(19) United States
(12) Patent Application Publication
(10) Pub. No.: US 2004/0263718 A1
(43) Pub. Date: Dec. 30, 2004

(54) Backlight module and liquid crystal display device using the same

(76) Inventor: Kun-Jung Tsai, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/883,418

(22) Filed: Jun. 30, 2004

(30) Foreign Application Priority Data
Jun. 30, 2003 (TW) 92117873

(51) Int. Cl. G02F 1/1335

(52) U.S. Cl. 349/62

(57) ABSTRACT

A backlight module (2) includes two light sources (21, 22) and a light guide plate (20). The light guide plate includes two light incidence surfaces (24, 26) corresponding to the light sources respectively, a light emitting surface (25), and a bottom surface (23) opposite to the light emitting surface. A pattern of micro dots (27) is disposed on the bottom surface. Sizes of the micro dots are configured according to the positions and irradiance characteristics of the light sources. This gives the micro dots suitable reflective capabilities so that they collectively generate uniform emission of light beams from the light emitting surface. A corresponding liquid crystal display device (3) includes the above-described backlight module, and a liquid crystal panel (4) disposed above the light guide plate of the backlight module.

### BACKGROUND OF THE INVENTION

1. Field of the Invention

The present invention relates to a backlight module and a liquid crystal display (LCD) device employing the backlight module.

2. Description of Prior Art

Because a liquid crystal display (LCD) device has the merits of being thin, light in weight, and drivable by a low voltage, it is extensively employed in various electronic devices.

In an LCD device, the liquid crystal panel does not itself emit light, but rather serves as a controlling element to manage the transmission of light beams. An LCD device needs uniform illumination in order to obtain an excellent quality display. Usually a backlight module having a light source and light guiding means is used to provide such illumination. The light source emits light beams to the light guiding means, which then transmits the light beams to illuminate liquid crystal molecules in the liquid crystal panel. The light guiding means generally has a so-called dot pattern structure, for ensuring that light beams are uniformly emitted to the liquid crystal panel.

A detailed explanation of a typical backlight module is provided hereinbelow, with reference to FIG. 4. The backlight module 1 has a light source 11 that is a Cold Cathode Fluorescent Lamp (CCFL), and a light guide plate 10. The light guide plate 10 includes a light incidence surface 14 adjacent to the light source 11, a reflection surface 16 opposite to the light incidence surface 14, a light emitting surface (not visible), and a bottom surface 13 opposite to the light emitting surface. A plurality of micro dots 17 is disposed on the bottom surface 13. Respective projection areas of the micro dots 17 on the bottom surface 13 become progressively larger with increasing distance away from the light incidence surface 14. This enables the micro dots 17 further away from the light source 11 to have stronger reflective capabilities. Since the intensity of light beams decreases with increasing distance away from the light incidence surface 14, the configuration of the micro dots 17 enables the light beams to emit more uniformly over the whole light emitting surface of the light guide plate 10.

However, the configuration of increasing size of the micro dots 17 is not precisely determined in relation to variable structural characteristics such as the size of the light guide plate 10, the position of the light source 11, and the illumination characteristics of the light source 11. Thus the backlight module 1 has limited capability to produce uniform light beams.

Further, there is ongoing demand for improved visual performance of LCD devices, thereby necessitating even more uniform illumination for these devices. High-end LCD devices nowadays frequently have a backlight module with two or more light sources therein. Such kind of high-end backlight module is even more limited in capability to produce uniform light beams than the backlight module 1, because the high-end backlight module possesses the additional variables of the number of light sources and the respective positions and illumination characteristics of the light sources.

It is desired to provide an improved liquid crystal display device which overcomes the above-described problems.

### SUMMARY OF THE INVENTION

It is an object of the present invention to provide a backlight module providing highly uniform illumination, and a liquid crystal display device incorporating such a backlight module.

A backlight module of the present invention comprises two opposite light sources and a light guide plate. The light guide plate comprises two light incidence surfaces corresponding to the light sources respectively, a light emitting surface, and a bottom surface opposite to the light emitting surface. A plurality of micro dots is disposed on the bottom surface. Sizes of the micro dots are configured according to the positions and irradiance characteristics of the light sources. This gives the micro dots suitable reflective capabilities so that they collectively generate uniform emission of light beams from the light emitting surface.

A liquid crystal display device of the present invention comprises the above-described backlight module, and a liquid crystal panel disposed above the light guide plate of the backlight module.

Other objects, advantages, and novel features of the present invention will become more apparent from the following detailed description when taken in conjunction with the accompanying drawings.

### BRIEF DESCRIPTION OF THE DRAWINGS

FIG. 1 is an isometric view of a backlight module according to the present invention.

FIG. 2 is a bottom elevation of the backlight module of FIG. 1, viewed with reference to Cartesian axes.

FIG. 3 is a side elevation of a liquid crystal display device according to the present invention, the liquid crystal display device comprising the backlight module of FIG. 1.

FIG. 4 is a bottom elevation of a conventional backlight module.

### DETAILED DESCRIPTION OF THE PRESENT INVENTION

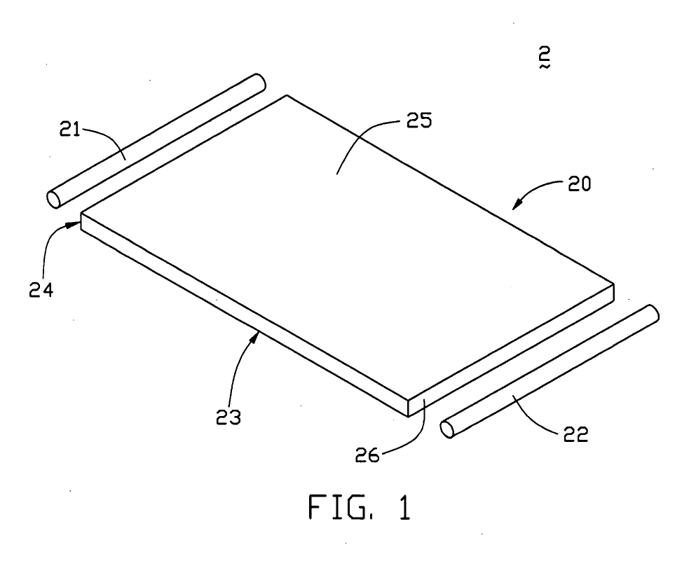

Referring to FIG. 1, a backlight module 2 of a preferred embodiment of the present invention includes two light sources 21, 22, and a light guide plate 20 disposed therebetween. The light guide plate 20 is made of a transparent material such as glass or acrylic. The light guide plate 20 comprises two light incidence surfaces 24, 26 facing the light sources 21, 22 respectively, a top light emitting surface 25, and a bottom surface 23 opposite to the light emitting surface 25.

Light beams irradiated from the light sources 21, 22 enter into the light guide plate 20 through the light incidence surfaces 24, 26. A reflection plate or a reflection film (not shown) is disposed under the bottom surface 23, to reflect light beams out through the light emitting surface 25. In order to obtain uniformity of outgoing light beams, a pattern of micro dots 27 is formed on the bottom surface 23 to diffuse reflected light beams. The micro dots 27 can be protrusive or depressed portions of the light guide plate 20. Alternatively, the micro dots 27 can be another kind of material disposed in or on the light guide plate 20. The micro dots 27 can be manufactured by injection molding, printing, or another suitable method.

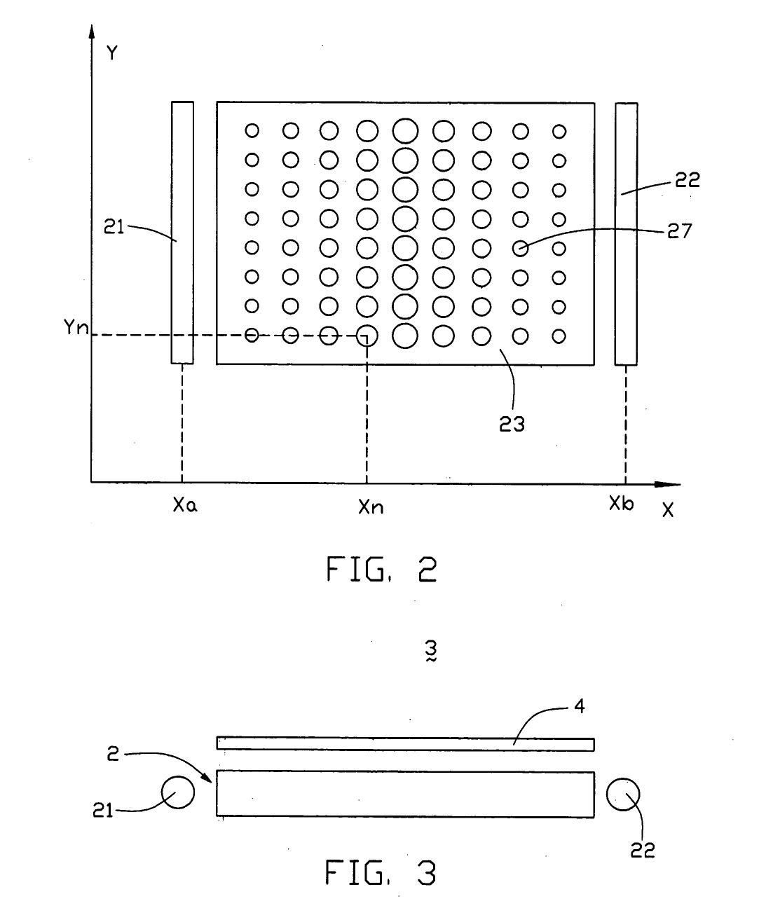

Referring to FIG. 2, the light sources 21, 22 are linear light sources, and are parallel with each other. Using the linear light source direction as a Y-axis, a Cartesian coordinate system is defined accordingly. The pattern of micro dots 27 is provided on the bottom surface 23 in a matrix formation. Projections of the micro dots 27 on the bottom surface are circular. The micro dots 27 have a radius R (Xₙ, Yₙ), centered at (Xₙ, Yₙ). To diffuse light beams uniformly at the bottom surface 23, the radius of each micro dot 27 satisfies the following equation:

$$R ( {X}_{n} , {Y}_{n} ) = {R}_{0} + k \sqrt{\frac{1}{\frac{{F}_{a} ( {Y}_{n} )}{{( {X}_{n} - {X}_{a} )}^{2}} + \frac{{F}_{b} ( {Y}_{n} )}{{( {X}_{n} - {X}_{b} )}^{2}}}}$$

wherein R₀ and k are coefficients (see below), Xₐ, X_{b} are coordinates of the two light sources 21, 22 respectively, and Fₐ, F_{b} are the irradiance characteristics of the light sources 21, 22 in Xₐ, X_{b} respectively, Fₐ, F_{b} showing the relation between intensity of light and the position for measuring.

For any location on the bottom surface 23, the intensity of light beams arriving there depends on the distance to each of the light sources 21, 22 and the irradiance characteristics of the light sources 21, 22. As shown in the above equation, a radius of the projection of each micro dot 27 is the sum of two terms, a least radius R₀ and a variable term. The variable term relates to the distances to the light sources 21, 22, and the light emitting functions of the light sources 21, 22. That is, the variable term relates to the differences in intensities of light beams at various locations on the bottom surface 23. Thus, the micro dots 27 as defined by the above equation have different sizes at various locations, so that the pattern of micro dots 27 compensates for the differences in intensities of light beams. This gives the micro dots 27 suitable reflective capabilities so that they collectively generate uniform emission of light beams from the light emitting surface 25.

In some cases, brighter illumination is required, necessitating additional light sources. The above-described means for compensating for the differences in intensities of light beams at different locations on the bottom surface 23 can still apply with equal efficacy. The variable term in the above equation can simply relate to the respective distances to all the light sources and the irradiance characteristics of all the light sources.

In manufacturing the light guide plate 20, the coefficients R₀ and k can be adjusted so that the light guide plate 20 can reflect light beams efficiently and accurately.

Compared with a conventional backlight module, the backlight module 2 has the pattern of micro dots 27 specially configured according to the actual light sources 21, 22 and their irradiance characteristics. That is, the micro dots 27 have different reflective capabilities according to their locations. Therefore, the backlight module 2 generates more uniform illumination.

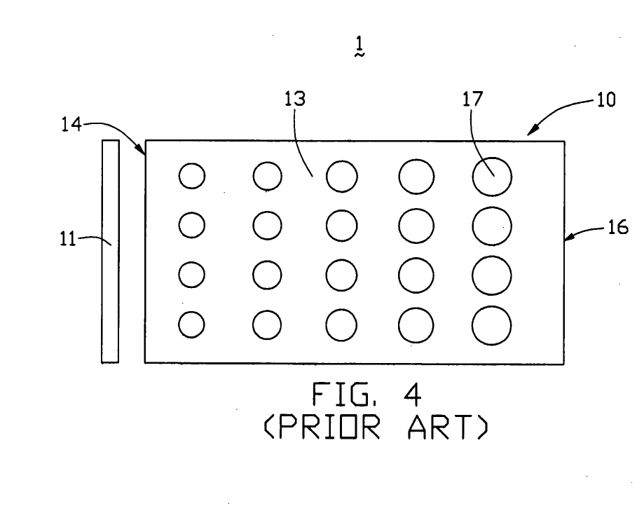

Referring to FIG. 3, a liquid crystal display device 3 of the preferred embodiment of the present invention employs the backlight module 2. The light guide plate 20 of the backlight module 2 is disposed under a liquid crystal panel 4, in order to provide uniform illumination to the liquid crystal panel 4.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A backlight module, comprising:
two light sources; and
a light guide plate comprising two light incidence surfaces corresponding to the light sources respectively, a light emitting surface, and a bottom surface opposite to the light emitting surface;
wherein a plurality of micro dots is disposed on the bottom surface, and sizes of the micro dots are configured according to the positions and irradiance characteristics of the light sources.

2. The backlight module as claimed in claim 1, wherein a radius of each micro dot satisfies the following equation:
$$R ( {X}_{n} , {Y}_{n} ) = {R}_{0} + k \sqrt{\frac{1}{\frac{{F}_{a} ( {Y}_{n} )}{{( {X}_{n} - {X}_{a} )}^{2}} + \frac{{F}_{b} ( {Y}_{n} )}{{( {X}_{n} - {X}_{b} )}^{2}}}}$$
wherein Xₙ, Yₙ are Cartesian coordinates of the center of the micro dot, R is the radius of the micro dot, R₀ and k are coefficients, Xₐ, X_{b} are Cartesian coordinates of the light sources respectively, and Fₐ, F_{b} are light emitting functions of the light sources in Xₐ, X_{b} respectively.

3. The backlight module as claimed in claim 2, wherein the micro dots are round protrusions.

4. The backlight module as claimed in claim 2, wherein the micro dots are round recesses.

5. The backlight module as claimed in claim 2, wherein the micro dots are made by way of printing.

6. The backlight module as claimed in claim 2, wherein the micro dots are made by way of injection molding.

7. A liquid crystal display device, comprising:
a liquid crystal panel; and
a backlight module for illuminating the liquid crystal panel;
wherein the backlight module comprises two light sources, and a light guide plate comprising two light incidence surfaces corresponding to the light sources respectively, a light emitting surface, and a bottom surface opposite to the light emitting surface; and
a plurality of micro dots is disposed on the bottom surface, and sizes of the micro dots are configured according to the positions and irradiance characteristics of the light sources.

8. The liquid crystal display device as claimed in claim 7, wherein a radius of each micro dot satisfies the following equation:
$$R ( {X}_{n} , {Y}_{n} ) = {R}_{0} + k \sqrt{\frac{1}{\frac{{F}_{a} ( {Y}_{n} )}{{( {X}_{n} - {X}_{a} )}^{2}} + \frac{{F}_{b} ( {Y}_{n} )}{{( {X}_{n} - {X}_{b} )}^{2}}}}$$
wherein Xₙ, Yₙ are Cartesian coordinates of a center of the micro dot, R is the radius of the micro dot, R₀ and k are coefficients, Xₐ, X_{b} are Cartesian coordinates of the light sources respectively, and Fₐ, F_{b} are light emitting functions of the light sources in Xₐ, X_{b} respectively.

9. The liquid crystal display device as claimed in claim 8, wherein the micro dots are round protrusions.

10. The liquid crystal display device as claimed in claim 8, wherein the micro dots are round recesses.

11. The liquid crystal display device as claimed in claim 8, wherein the micro dots are made by way of printing.

12. The liquid crystal display device as claimed in claim 8, wherein the micro dots are made by way of injection molding.

13. A backlight module, comprising:
two parallel light sources; and
a light guide plate comprising two parallel light incidence surfaces corresponding to the light sources respectively, a light emitting surface, and a bottom surface opposite to the light emitting surface;
wherein a plurality of micro dots is disposed on the bottom surface,. wherein a radius of each micro dot satisfies the following equation:
$$R ( {X}_{n} , {Y}_{n} ) = {R}_{0} + k \sqrt{\frac{1}{\frac{{F}_{a} ( {Y}_{n} )}{{( {X}_{n} - {X}_{a} )}^{2}} + \frac{{F}_{b} ( {Y}_{n} )}{{( {X}_{n} - {X}_{b} )}^{2}}}}$$
wherein Xn, Yn are Cartesian coordinates of the center of the micro dot, R is the radius of the micro dot, R0 and k are coefficients, Xa, Xb are Cartesian coordinates of the light sources respectively, and Fa, Fb are light emitting functions of the light sources in Xa, Xb respectively.
